(19) United States
(12) Patent Application Publication
(10) Pub. No.: US 2016/0021288 A1
(43) Pub. Date: Jan. 21, 2016

(54) VEHICLE-REVERSING DISPLAY SYSTEM CAPABLE OF AUTOMATICALLY SWITCHING MULTIPLE FIELD-OF-VIEW MODES AND VEHICLE-REVERSING IMAGE CAPTURE DEVICE

(71) Applicant: Seeways Technology Inc., Taipei City (TW)

(72) Inventor: CHONG-RON CHEN, Taipei City (TW)

(21) Appl. No.: 14/736,800

(22) Filed: Jun. 11, 2015

(30) Foreign Application Priority Data
Jul. 18, 2014 (TW) 103212824

(51) Int. Cl. H04N 5/225; G06K 9/00; G06K 9/32; H04N 7/18

(52) U.S. Cl. CPC H04N 5/2259; H04N 7/183; G06K 9/00805; G06K 9/00812; G06K 9/32; G06K 2209/21

(57) ABSTRACT

A vehicle-reversing display system includes a controller area network, an ultrasonic sensor, a vehicle-reversing image capture device and a display device. The vehicle-reversing image capture device includes a controlling unit and a camera. After a vehicle-reversing parameter of the controller area network is acquired, the controlling unit recognizes a distance from an obstacle through the ultrasonic sensor. If the distance is a first distance, the camera is automatically switched to a wide field-of-view mode under control of the controlling unit. If the distance is a second distance, the camera is automatically switched to a normal field-of-view mode under control of the controlling unit. If the distance is a third distance, the camera is automatically switched to a top field-of-view mode under control of the controlling unit. An auxiliary image is displayed on the display device.

### FIELD OF THE INVENTION

The present invention relates to a vehicle-reversing display system, and more particularly to a vehicle-reversing display system capable of automatically switching multiple field-of-view modes and a vehicle-reversing image capture device thereof according to the distance of an obstacle from the vehicle.

### BACKGROUND OF THE INVENTION

With the increasing development of the transmission system and the materials science and the economic growth, vehicles have high flexibility and popularity. Consequently, the users spend less time going to their destinations. As the number of the vehicle users gradually increases, vehicle safety is getting more and more important.

Conventionally, the vehicle safety techniques are aimed at the improvements about the field of view (FOV) of the travelling vehicle and the safety distance between a specified vehicle and the vehicles at the front side, rear side, left side, or right side of the specified vehicle. Moreover, the researches about the auxiliary vehicle-reversing devices were published. With the enhancement of safety awareness, ultrasonic sensors or vehicle-reversing camera are widely applied to the current auxiliary vehicle-reversing devices. Generally, when a sound wave reflected from an obstacle is detected by the ultrasonic sensor, a warning sound is generated. However, the effective echo depth of the conventional ultrasonic sensor is at most 90-150 centimeters. Moreover, if the detecting height is lower than 30-45 centimeters, the conventional ultrasonic sensor is unable to effectively detect the obstacle. Moreover, since the width of the ultrasonic sensor is fan-shaped, a blind zone is formed behind the vehicle. In case that an obstacle is in the blind zone, the echo depth, the detecting height and the detecting width are undetectable. Moreover, when the obstacle behind the vehicle is sensed by the ultrasonic sensor, only the warning sound is generated to notify the driver. However, since the driver cannot realize the distance or the position of the obstacle through the ultrasonic sensor, the driver cannot realize the real situation behind the vehicle by the ultrasonic sensor.

Nowadays, a vehicle-reversing camera and an ultrasonic sensor are collaboratively used to display the scene behind the vehicle. However, since the horizontal viewing angle of the vehicle-reversing camera is at most 140 to 150, the narrow viewing angle may result in a blind zone. Moreover, the field of view of the vehicle-reversing camera cannot be automatically adjusted. Consequently, if the vehicle is close to an object with a vertical plane, the possibility of causing collision or accident increases because the vehicle-reversing camera cannot capture the image of the scene from the top field of view. For example, if a ravine, a cliff, a harbor embankment or any other object with the vertical plane is behind a vehicle, the driver cannot judge the real situation behind the vehicle because the image cannot be captured from the top field of view. Consequently, the rear wheels possibly fell into the ravine or the cliff, or collide with the harbor embankment.

Therefore, there is a need of provides an improved vehicle-reversing display system and an improved vehicle-reversing image capture device in order to overcome the above drawbacks.

### SUMMARY OF THE INVENTION

An object of the present invention provides a vehicle-reversing display system capable of automatically switching multiple field-of-view modes and a vehicle-reversing image capture device thereof according to the distance from the vehicle. Consequently, an auxiliary image corresponding to a wide field-of-view mode, a normal field-of-view mode, or a top field-of-view mode is displayed on the display device. According to the auxiliary image, the driver can realize the real situation behind the vehicle while reversing the vehicle.

In accordance with an aspect of the present invention, there is provided a vehicle-reversing display system capable of automatically switching multiple field-of-view modes. The vehicle-reversing display system includes a controller area network, an ultrasonic sensor, a vehicle-reversing image capture device, and a display device. The controller area network provides a vehicle-reversing parameter. The ultrasonic sensor is connected with the controller area network. The vehicle-reversing image capture device includes a controlling unit and a camera. The controlling unit is connected with the controller area network. The camera is connected with the controlling unit. The display device is connected with the camera. After the vehicle-reversing parameter of the controller area network is acquired by the controlling unit, the controlling unit recognizes a distance from an obstacle through the ultrasonic sensor. If the distance is a first distance, the camera is automatically switched to a wide field-of-view mode under control of the controlling unit. If the distance is a second distance, the camera is automatically switched to a normal field-of-view mode under control of the controlling unit. If the distance is a third distance, the camera is automatically switched to a top field-of-view mode under control of the controlling unit. An auxiliary image corresponding to the wide field-of-view mode, the normal field-of-view mode, or the top field-of-view mode is captured by the camera and displayed on the display device.

In accordance with another aspect of the present invention, there is provided a vehicle-reversing image capture device of a vehicle-reversing display system. The vehicle-reversing display system includes a controller area network, an ultrasonic sensor and a display device. The vehicle-reversing image capture device includes a controlling unit and a camera. The controlling unit is connected with the controller area network. The camera is connected with the controlling unit. After a vehicle-reversing parameter of the controller area network is acquired by the controlling unit, the controlling unit recognizes a distance from an obstacle through the ultrasonic sensor. If the distance is a first distance, the camera is automatically switched to a wide field-of-view mode under control of the controlling unit. If the distance is a second distance, the camera is automatically switched to a normal field-of-view mode under control of the controlling unit. If the distance is a third distance, the camera is automatically switched to a top field-of-view mode under control of the controlling unit. An auxiliary image corresponding to the wide field-of-view mode, the normal field-of-view mode, or the top field-of-view mode is captured by the camera and displayed on the display device.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a vehicle-reversing display system capable of automatically switching multiple field-of-view modes according to an embodiment of the present invention;

FIG. 2A schematic illustrates the relationship between the vehicle and an obstacle, in which the distance between the vehicle and the obstacle is a first distance;

FIG. 2B is an auxiliary image captured by the camera of the vehicle-reversing display system of the vehicle as shown in FIG. 2A;

FIG. 3A schematic illustrates the relationship between the vehicle and an obstacle, in which the distance between the vehicle and the obstacle is a second distance;

FIG. 3B is an auxiliary image captured by the camera of the vehicle-reversing display system of the vehicle as shown in FIG. 3A;

FIG. 4A schematic illustrates the relationship between the vehicle and an obstacle, in which the distance between the vehicle and the obstacle is a third distance; and

FIG. 4B is an auxiliary image captured by the camera of the vehicle-reversing display system of the vehicle as shown in FIG. 4A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

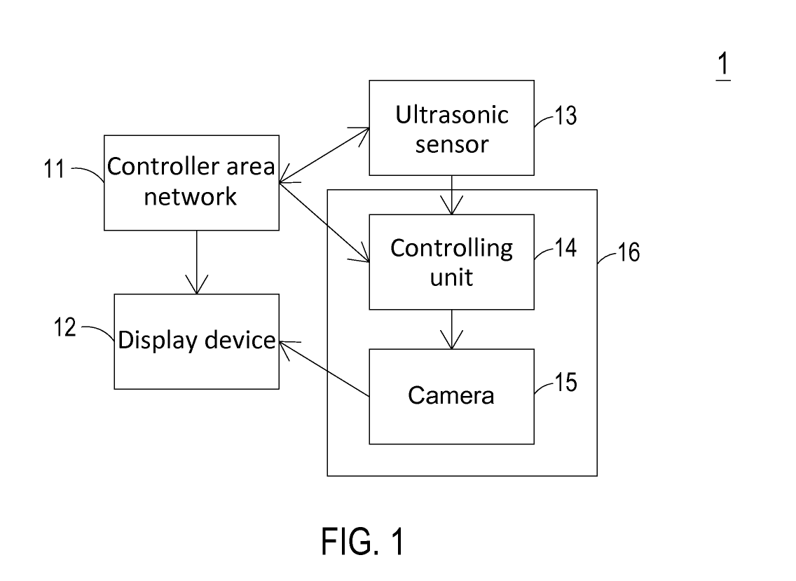

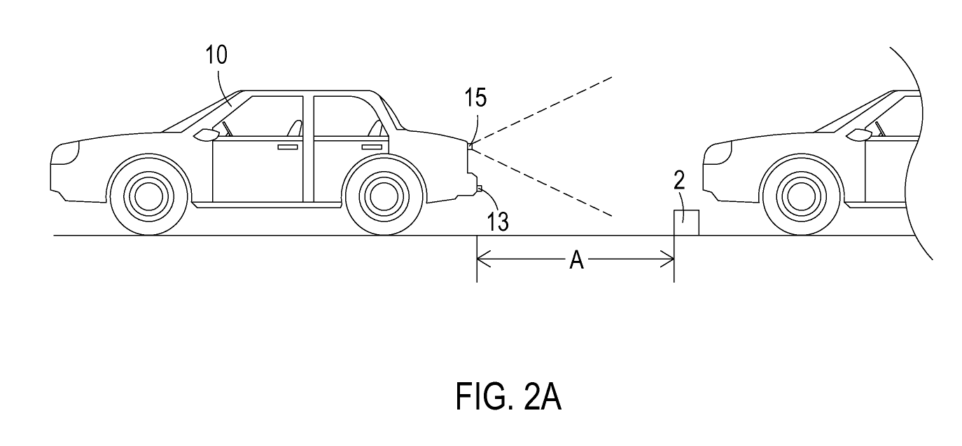

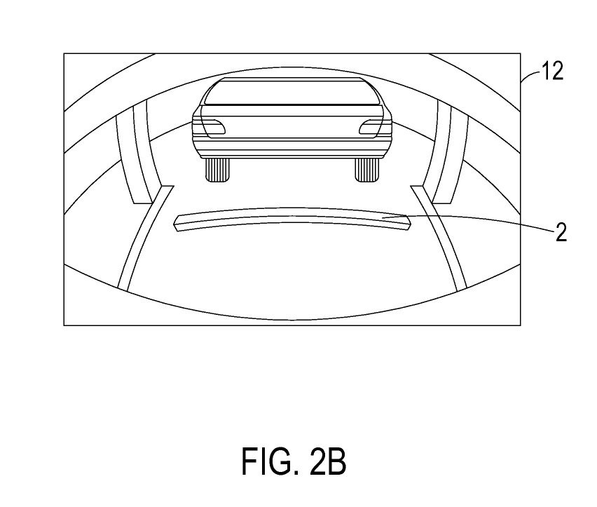

FIG. 1 is a schematic functional block diagram illustrating a vehicle-reversing display system capable of automatically switching multiple field-of-view modes according to an embodiment of the present invention. The vehicle-reversing display system 1 capable of automatically switching multiple field-of-view modes (hereinafter referred to as the vehicle-reversing display system) is applied to a vehicle 10 (see FIG. 2A). The vehicle-reversing display system 1 comprises a controller area network (also referred as a CAN Bus) 11, a display device 12, an ultrasonic sensor 13 and a vehicle-reversing image capture device 16. The controller area network 11 is connected with a vehicular computer (not shown). The vehicular computer is installed in the vehicle 10 for providing plural vehicle operating parameters. The plural vehicle operating parameters indicate the current operating statuses of the vehicle 10. The controller area network 11 is connected with the vehicular computer for providing a vehicle-reversing parameter (e.g., a reverse gear shift of the vehicle 10).

In this embodiment, the ultrasonic sensor 13 is connected with the controller area network 11, and located at a rear bumper of the vehicle 10 (see FIG. 2A). It is noted that the position of the ultrasonic sensor 13 is not restricted. An example of the ultrasonic sensor 13 includes but is not limited to an ultrasonic reverse parking radar. In case that the vehicle 10 has an ultrasonic reverse parking radar, the ultrasonic reverse parking radar can be used as the ultrasonic sensor 13. Under this circumstance, it is not necessary to additionally install a new ultrasonic sensor.

Please refer to FIG. 1 again. The vehicle-reversing image capture device 16 comprises a controlling unit 14 and a camera 15. The controlling unit 14 is connected with the controller area network 11. The camera 15 is connected with the controlling unit 14, and located at a rear side of the vehicle 10 (see FIG. 2A). The camera 15 is used for capturing a scene behind the vehicle 10. It is noted that the position and the type of the camera 15 are not restricted. An example of the camera 15 includes but is not limited to an ordinary camera, a wide-angle camera, or a fisheye camera (i.e., an ultra wide-angle camera). The display device 12 is installed in the vehicle 10 and connected with the camera 15. After the vehicle-reversing parameter of the controller area network 11 is acquired by the controlling unit 14 of the vehicle-reversing image capture device 16, the controlling unit 14 recognizes a distance from an obstacle 2 through the ultrasonic sensor 13 (see FIG. 2A).

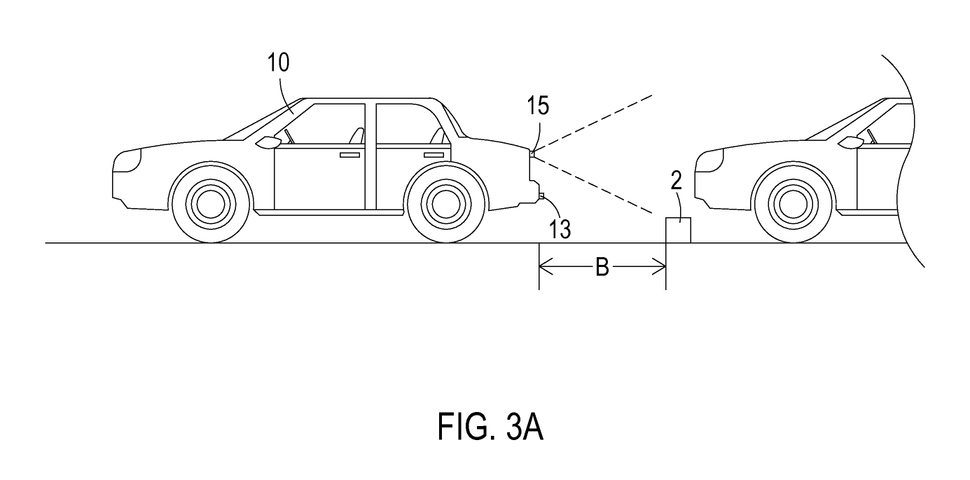

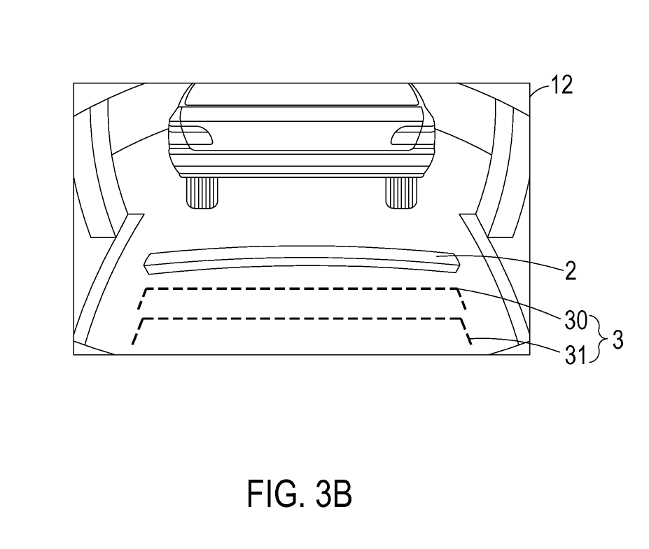

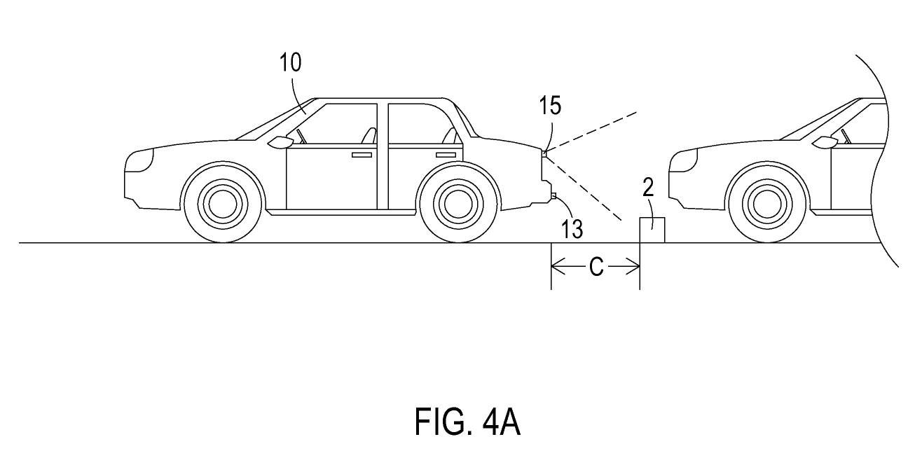

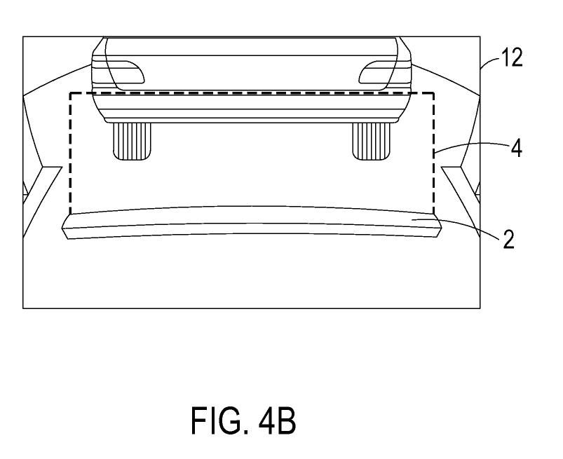

In accordance with a feature of the present invention, the display mode of the camera 15 is automatically adjusted by the controlling unit 14 according to the distance between the camera 15 and the obstacle 2. In case that the distance is a first distance A (e.g., a longer distance as shown in FIG. 2A), the camera 15 is automatically switched to a wide field-of-view mode under control of the controlling unit 14. In case that the distance is a second distance B (e.g., a medium distance as shown in FIG. 3A), the camera 15 is automatically switched to a normal field-of-view mode under control of the controlling unit 14. In case that the distance is a third distance C (e.g., a shorter distance as shown in FIG. 4A), the camera 15 is automatically switched to a top field-of-view mode under control of the controlling unit 14. Consequently, an auxiliary image corresponding to the wide field-of-view mode, the normal field-of-view mode, or the top field-of-view mode is displayed on the display device 12.

FIG. 2A schematic illustrates the relationship between the vehicle and an obstacle, in which the distance between the vehicle and the obstacle is a first distance. FIG. 2B is an auxiliary image captured by the camera of the vehicle-reversing display system of the vehicle as shown in FIG. 2A. After the vehicle-reversing parameter of the controller area network 11 is acquired by the controlling unit 14 of the vehicle-reversing image capture device 16, the controlling unit 14 realizes that the gear shift of the vehicle 10 is the reverse gear shift and the controlling unit 14 recognizes a first distance A from an obstacle 2 through the ultrasonic sensor 13. Since the first distance A is relatively longer, the camera 15 is automatically switched to the wide field-of-view mode under control of the controlling unit 14. Consequently, as shown in FIG. 2B, the auxiliary image corresponding to the wide field-of-view mode is displayed on the display device 12. Through the auxiliary image corresponding to the wide field-of-view mode, the driver can realize the position of the obstacle 2. That is, the auxiliary image can assist the driver to start reversing the vehicle 10. For example, the first distance A is longer than 1 meter, and preferably in the range between 1 and 3 meters. Moreover, the horizontal viewing angle of the camera 15 in the wide field-of-view mode is in the range between 170 and 190 degrees.

FIG. 3A schematic illustrates the relationship between the vehicle and an obstacle, in which the distance between the vehicle and the obstacle is a second distance. FIG. 3B is an auxiliary image captured by the camera of the vehicle-reversing display system of the vehicle as shown in FIG. 3A. After the vehicle-reversing parameter of the controller area network 11 is acquired by the controlling unit 14 of the vehicle-reversing image capture device 16, the controlling unit 14 recognizes a second distance B from the obstacle 2 through the ultrasonic sensor 13. Since the second distance B is the medium distance, the camera 15 is automatically switched to the normal field-of-view mode under control of the controlling unit 14. Consequently, as shown in FIG. 3B, the auxiliary image corresponding to the normal field-of-view mode is displayed on the display device 12. Through the auxiliary image corresponding to the wide field-of-view mode, the driver can realize the position of the obstacle 2. That is, the auxiliary image can assist the driver to reverse and park the vehicle 10. Preferably but not exclusively, the second distance B is in the range between 0.5 and 1 meter. Moreover, the horizontal viewing angle of the camera 15 in the normal field-of-view mode is in the range between 110 and 150 degrees. Moreover, for further assisting the driver to reverse and park the vehicle 10, plural virtual parking lines 3 are contained in the auxiliary image corresponding to the normal field-of-view mode. As shown in FIG. 3B, two parking lines 30 and 31 are contained in the auxiliary image. It is noted that the number of parking lines is not restricted. According to the parking lines, the driver can estimate the distance of the vehicle from the rear obstacle 2. Consequently, the possibility of causing collision will be minimized.

FIG. 4A schematic illustrates the relationship between the vehicle and an obstacle, in which the distance between the vehicle and the obstacle is a third distance. FIG. 4B is an auxiliary image captured by the camera of the vehicle-reversing display system of the vehicle as shown in FIG. 4A. After the vehicle-reversing parameter of the controller area network 11 is acquired by the controlling unit 14 of the vehicle-reversing image capture device 16, the controlling unit 14 recognizes a third distance C from the obstacle 2 through the ultrasonic sensor 13. Since the third distance C is the shorter distance, the camera 15 is automatically switched to the top field-of-view mode under control of the controlling unit 14. Consequently, as shown in FIG. 4B, the auxiliary image corresponding to the top field-of-view mode is displayed on the display device 12. Although the field of view corresponding to the shorter distance in the vertical direction is impaired, the auxiliary image captured by the camera 15 in the top field-of-view mode can assist the driver to recognize the distance of the vehicle 10 from the obstacle 2. Consequently, the possibility of causing collision or accident will be minimized. Preferably but not exclusively, the third distance C shorter than 0.5 meter. Moreover, the vertical viewing angle of the camera 15 in the top field-of-view mode is in the range between 60 and 90 degrees. Moreover, for further assisting the driver to reverse and park the vehicle 10, a vertical virtual parking mark 4 (e.g., an inverted U-shaped virtual parking mark) is contained in the auxiliary image corresponding to the top field-of-view mode. According to the parking line, the driver can estimate the distance of the vehicle from the rear obstacle 2. Consequently, the possibility of causing collision or accident will be minimized.

From the above descriptions, the present invention provides a vehicle-reversing display system. The vehicle-reversing display system includes a controller area network, an ultrasonic sensor, a display device and a vehicle-reversing image capture device. After a vehicle-reversing parameter of the controller area network is acquired by the controlling unit, the controlling unit recognizes a distance from an obstacle through the ultrasonic sensor. If the distance is a first distance, the camera is automatically switched to a wide field-of-view mode under control of the controlling unit. If the distance is a second distance, the camera is automatically switched to a normal field-of-view mode under control of the controlling unit. If the distance is a third distance, the camera is automatically switched to a top field-of-view mode under control of the controlling unit. An auxiliary image corresponding to the wide field-of-view mode, the normal field-of-view mode, or the top field-of-view mode is displayed on the display device. Since the depth sensed by the ultrasonic sensor is interpreted by the vehicle-reversing image capture device, the auxiliary image in the corresponding field-of-view mode is displayed on the display device according to the sensed depth. According to the auxiliary image, the driver can estimate the distance of the vehicle from the rear obstacle. Consequently, the possibility of causing collision or accident will be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A vehicle-reversing display system capable of automatically switching multiple field-of-view modes, comprising:
a controller area network providing a vehicle-reversing parameter;
an ultrasonic sensor connected with the controller area network;
a vehicle-reversing image capture device comprising a controlling unit and a camera, wherein the controlling unit is connected with the controller area network, and the camera is connected with the controlling unit; and
a display device connected with the camera,
wherein after the vehicle-reversing parameter of the controller area network is acquired by the controlling unit, the controlling unit recognizes a distance from an obstacle through the ultrasonic sensor, wherein if the distance is a first distance, the camera is automatically switched to a wide field-of-view mode under control of the controlling unit, wherein if the distance is a second distance, the camera is automatically switched to a normal field-of-view mode under control of the controlling unit, wherein if the distance is a third distance, the camera is automatically switched to a top field-of-view mode under control of the controlling unit, wherein an auxiliary image corresponding to the wide field-of-view mode, the normal field-of-view mode, or the top field-of-view mode is captured by the camera and displayed on the display device.

2. The vehicle-reversing display system according to claim 1, wherein the ultrasonic sensor is an ultrasonic reverse parking radar.

3. The vehicle-reversing display system according to claim 1, wherein the first distance is longer than 1 meter, the second distance is in a range between 0.5 and 1 meter, and the third distance is shorter than 0.5 meter.

4. The vehicle-reversing display system according to claim 1, wherein a horizontal viewing angle of the camera in the wide field-of-view mode is in a range between 170 and 190 degrees, a horizontal viewing angle of the camera in the normal field-of-view mode is in a range between 110 and 150 degrees, and a vertical viewing angle of the camera in the top field-of-view mode is in a range between 60 and 90 degrees.

5. The vehicle-reversing display system according to claim 1, wherein plural virtual parking lines are contained in the auxiliary image corresponding to the normal field-of-view mode.

6. The vehicle-reversing display system according to claim 1, wherein a vertical virtual parking mark is contained in the auxiliary image corresponding to the top field-of-view mode.

7. A vehicle-reversing image capture device of a vehicle-reversing display system, the vehicle-reversing display system comprising a controller area network, an ultrasonic sensor and a display device, the vehicle-reversing image capture device comprising:
a controlling unit connected with the controller area network;
a camera connected with the controlling unit,
wherein after a vehicle-reversing parameter of the controller area network is acquired by the controlling unit, the controlling unit recognizes a distance from an obstacle through the ultrasonic sensor, wherein if the distance is a first distance, the camera is automatically switched to a wide field-of-view mode under control of the controlling unit, wherein if the distance is a second distance, the camera is automatically switched to a normal field-of-view mode under control of the controlling unit, wherein if the distance is a third distance, the camera is automatically switched to a top field-of-view mode under control of the controlling unit, wherein an auxiliary image corresponding to the wide field-of-view mode, the normal field-of-view mode, or the top field-of-view mode is captured by the camera and displayed on the display device.

8. The vehicle-reversing image capture device according to claim 7, wherein the first distance is longer than 1 meter, the second distance is in a range between 0.5 and 1 meter, and the third distance is shorter than 0.5 meter.

9. The vehicle-reversing image capture device according to claim 7, wherein a horizontal viewing angle of the camera in the wide field-of-view mode is in a range between 170 and 190 degrees, a horizontal viewing angle of the camera in the normal field-of-view mode is in a range between 110 and 150 degrees, and a vertical viewing angle of the camera in the top field-of-view mode is in a range between 60 and 90 degrees.
